(19) United States
(12) Patent Application Publication
(10) Pub. No.: US 2007/0132791 A1
(43) Pub. Date: Jun. 14, 2007

(54) Display device with point-to-point transmitting technology

(76) Inventor: Chien-Yu Yi, Taoyuan (TW)

Correspondence Address: J.C. Patents, Inc., Suite 250, 4 Venture, Irvine, CA, 92618, US

(21) Appl. No.: 11/441,941

(22) Filed: May 25, 2006

(30) Foreign Application Priority Data
Dec. 8, 2005 (TW) 94143342

(51) Int. Cl. G09G 5/10

(52) U.S. Cl. 345/690

(57) ABSTRACT

A display device with point-to-point transmitting technology is provided. The display device comprises a smart panel and a image processor. Wherein, the smart panel comprises a plurality of source drivers ICs that are coupled to a pixel array for transmitting an image data to the pixel array to drive a plurality of pixels in the pixel array. In addition, the image processor couples to the source driver ICs through a plurality of image data buses, respectively. Each of the image data buses corresponds to one of the source driver ICs.

### CROSS-REFERENCE TO RELATED APPLICATION

This application claims the priority benefit of Taiwan application serial no. 94143342, filed on Dec. 8, 2005. All disclosure of the Taiwan application is incorporated herein by reference.

### BACKGROUND OF THE INVENTION

1. Field of the Invention

The present invention relates to a display device, and more particularly, to a display device with point-to-point transmitting technology that applies a smart panel.

2. Description of the Related Art

In order to provide high integrity to the display panel, a smart panel configuration has been proposed by the Panel Standard Work Group (PSWG). In such smart panel configuration, the existing function for controlling the timing of the panel and the image processor on the system side in the panel module configuration are integrated as one piece. Accordingly, the additional timing controller is not required in the panel, thus the purpose of reducing the module material cost is achieved.

For the smart panel, the timing controlling circuits are integrated on a system board. However, in the real case, the smart panel only integrates the drivers and needs to connect to the image processor on the system board through the connectors to receive the image data. For a panel with an SXGA resolution, two connectors are used by the image processor to transmit the control signal and the image data that are required by the drivers connecting to the smart panel. FIGS. 1A and 1B schematically show the pin definition tables of the connectors used in a conventional smart panel with an SXGA resolution. Wherein, FIG. 1A provides the definitions of each pin in the first connector, and FIG. 1B provides the definitions of each pin in the second connector.

### SUMMARY OF THE INVENTION

Therefore, it is an object of the present invention to provide a display device with point-to-point transmitting technology. With such point-to-point transmitting technology, the number of the data transmission lines is effectively decreased, which also reduces the number of the connectors, thus the purpose of reducing the manufacturing cost is achieved. Here, the so-called “point-to-point transmitting technology” is applying the point-to-point data transmission rather than the serial data transmission in the transmission protocol between the image processor for controlling the panel's timing and the source driver ICs.

The present invention provides a display device with point-to-point transmitting technology. The display device comprises a smart panel and an image processor for controlling the panel's timing. Wherein, the smart panel comprises a plurality of source drivers ICs that are coupled to a pixel array for transmitting an image data to the pixel array to drive a plurality of pixels in the pixel array. In addition, the image processor in the system side couples to the source driver ICs through a plurality of image data buses and connectors, respectively. Each of the image data buses corresponds to one of the source driver ICs.

In an embodiment of the present invention, if the resolution of the smart panel is SXGA, only one connector is required for the image processor to couple to the source driver ICs, and the connector has 50 pins.

In addition, each of the image data buses mentioned above at least comprises a red image data transmission line, a green image data transmission line, and a blue image data transmission line for transmitting the red image data, the green image data, and the blue image data to each of the source driver ICs, respectively.

### BRIEF DESCRIPTION DRAWINGS

The accompanying drawings are included to provide a further understanding of the invention, and are incorporated in and constitute a portion of this specification. The drawings illustrate embodiments of the invention, and together with the description, serve to explain the principles of the invention.

FIGS. 1A and 1B schematically show the pin definition tables of the connectors used in a conventional smart panel.

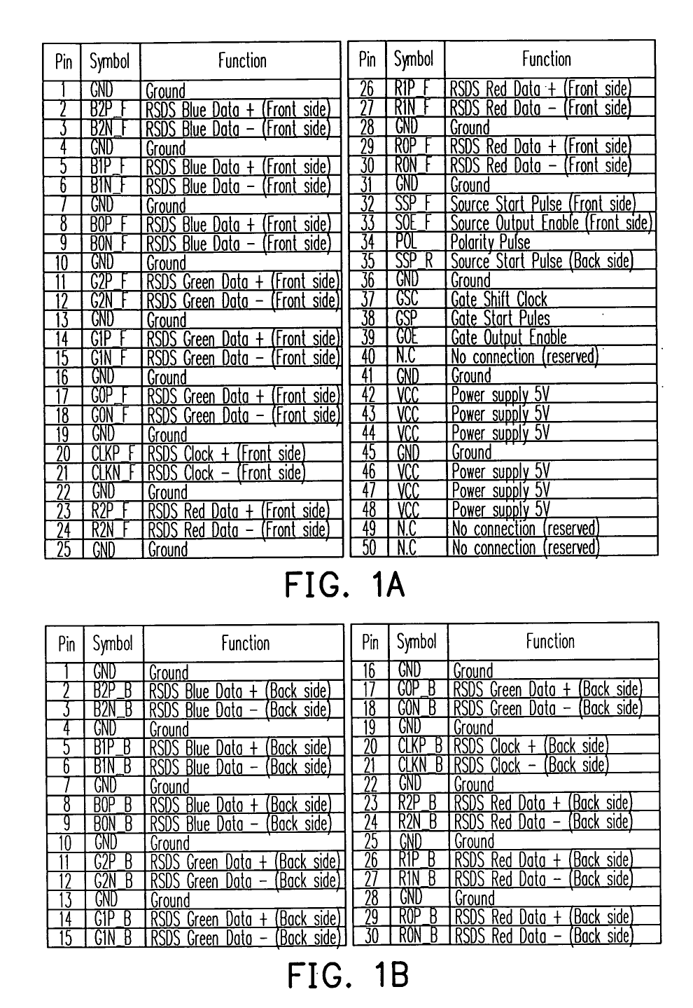

FIG. 2 schematically shows a partial circuit block diagram of a display device with point-to-point transmitting technology according to a preferred embodiment of the present invention.

FIG. 3 schematically shows a pin definition table of a connector according to an embodiment of the present invention.

FIG. 4 schematically shows a pin definition table of a connector according to another embodiment of the present invention.

### DESCRIPTION PREFERRED EMBODIMENTS

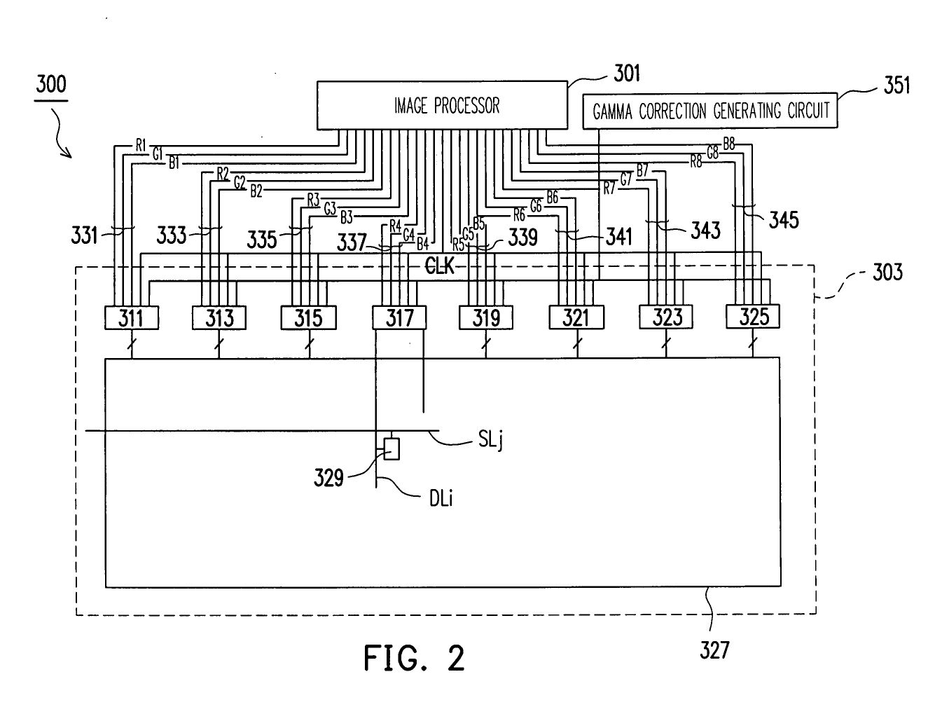

FIG. 2 schematically shows a partial circuit block diagram of a display device with point-to-point transmitting technology according to a preferred embodiment of the present invention. Here, the so-called “point-to-point transmitting technology” is applying the point-to-point data transmission rather than the serial data transmission in the transmission protocol between the image processor for controlling the panel's timing and the source driver ICs. Referring to FIG. 2, the display device 300 provided by the present invention comprises an image processor 301 and a smart panel 303. Wherein, the smart panel 303 comprises a plurality of driver ICs, such as the driver ICs 311, 313, 315, 317, 319, 321, 323, and 325. In addition, each of the driver ICs couples to a pixel array 327 through a plurality of data lines (e.g. DL1).

As well known by one of the ordinary skills in the art that the pixel array 327 comprises a plurality of data lines such as DL1 and a plurality of scan lines such as SLⱼ that are arranged perpendicularly to the data lines, respectively. In addition, a pixel such as the pixel 329 is disposed on an intersection of each of the data lines and the scan lines. Wherein, each driver sequentially transmits the image data from the connected data line to the pixel array 327 in order to drive pixels in the pixel array 327, respectively.

In the present invention, the image processor 301 is coupled to the corresponding source driver ICs 311˜325 through a plurality of image data buses (e.g. 331˜345), respectively. Wherein, each image data bus corresponds to one of the source driver ICs, respectively. For example, the image data buses 331, 333, 335, 337, 339, 341, 343, and 345 correspond to the source driver ICs 311, 313, 315, 317, 319, 321, 323, and 325, respectively.

Each image data bus comprises at least a red image data transmission line (e.g. R1˜R8), a green image data transmission line (e.g. G1˜G8), and a blue image data transmission line (e.g. B1˜B8). The image processor 301 uses these red, green and blue image data transmission lines to transmit the read, green, and blue image data to the corresponding source driver ICs 311˜325, respectively.

Moreover, the image processor 301 further generates and provides a control clock signal CLK to each source driver IC. In the present embodiment, the display device 300 further comprises a gamma correction generator 351 for generating and providing a gamma correction voltage to each source driver IC to perform the gamma correction.

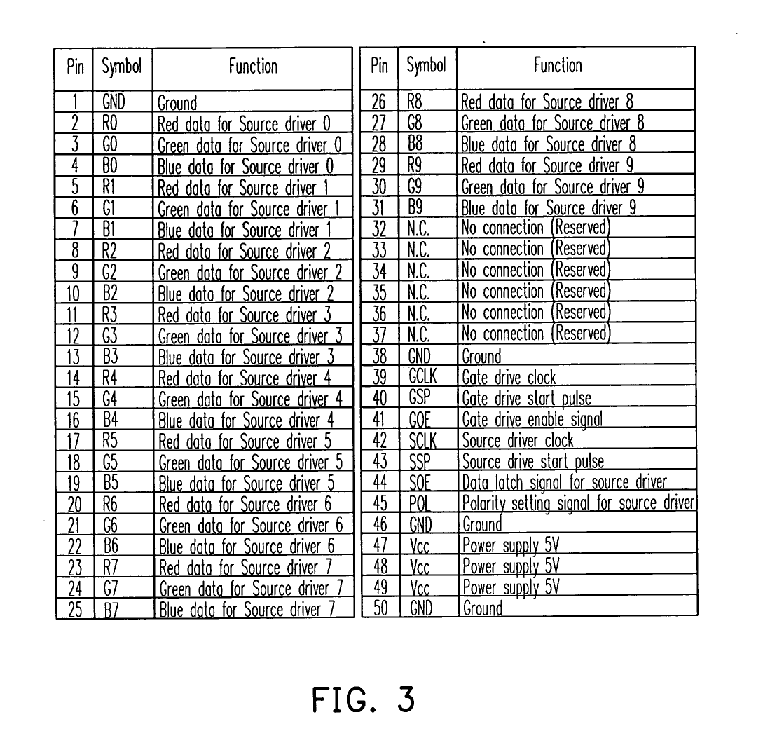

Although there are eight source driver ICs in FIG. 2, the present invention is not limited by it. For the SXGA resolution, the circuit designer can use ten source driver ICs each having 384 channels to drive the pixels in the pixel array. If ten source driver ICs each having 384 channels are used, only one connection with 50 pins is required by the image processor to connect to all source driver ICs on the smart panel. FIG. 3 schematically shows a pin definition table of a connector according to an embodiment of the present invention. As shown in FIG. 3, only one connector with 50 pins is required in the present invention to connect the output signal of the image processor to all source driver ICs on the smart panel.

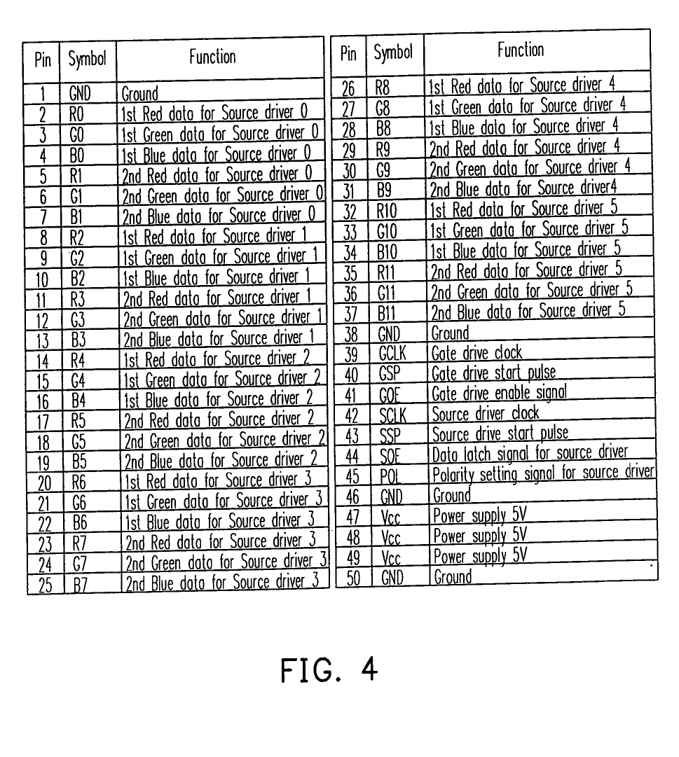

In another optional embodiment, the Electro Magnetic Interference (EMI) is reduced by applying a frequency-dividing method. In such case, each source driver IC receives two sets of red, green, and blue image data. Meanwhile, the designer can select six source driver ICs, each having 642 channels to drive the pixels in the pixel array. Similarly, the designer can only select one connector with 50 pins to connect the output signal of the image processor to all source driver ICs on the smart panel. FIG. 4 schematically shows a pin definition table of a connector according to another embodiment of the present invention suitable for a case where six source driver ICs each having 642 channels are used.

Even though FIGS. 3 and 4 provide the pin definition tables for the connectors, the present invention is not limited by it. One of the ordinary skills in the art can define the function of each pin of the connector based on the physical requirement.

In summary, since point-to-point transmitting technology is applied in the present invention, the bit number of the buses is effectively decreased. Accordingly, a less number of the connectors is required to connect the output of the image processor to all source driver ICs. Furthermore, since the number of the connectors is reduced, the manufacturing cost of the display device provided by the present invention is decreased.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. A display device with point-to-point transmitting technology, comprising:
a smart panel, comprising:
a pixel array having a plurality of pixels that are arranged in an array; and
a plurality of source driver ICs coupled to the pixel array for transmitting an image data to the pixel array to drive each of the pixels, respectively; and
an image processor coupled to the source driver ICs through a plurality of image data buses respectively, wherein each of the image data buses corresponds to one of the source driver ICs, respectively.

2. The display device with point-to-point transmitting technology of claim 1, further comprising a connector for transmitting an output signal from the image processor to each of the source driver ICs.

3. The display device with point-to-point transmitting technology of claim 1, wherein when the resolution of the smart panel is SXGA, only one connector is required by the image processor to connect to the source driver ICs.

4. The display device with point-to-point transmitting technology of claim 3, wherein the connector has 50 pins.

5. The display device with point-to-point transmitting technology of claim 1, wherein each of the image data buses at least comprises:
a red image data transmission line for transmitting a red image data to a corresponding source driver IC;
a green image data transmission line for transmitting a green image data to a corresponding source driver IC; and
a blue image data transmission line for transmitting a blue image data to a corresponding source driver IC.

6. The display device with point-to-point transmitting technology of claim 5, wherein each of the image data buses at least comprises:
a pair of red image data transmission lines for transmitting a red image data to a corresponding source driver IC;
a pair of green image data transmission lines for transmitting a green image data to a corresponding source driver IC; and
a pair of blue image data transmission lines for transmitting a blue image data to a corresponding source driver IC.

7. The display device with point-to-point transmitting technology of claim 1, further comprising a gamma correction generator for generating and providing a gamma correction voltage to the source driver ICs.

8. The display device with point-to-point transmitting technology of claim 1, wherein the image processor provides a control clock signal to the source driver ICs.
